(19) United States
(12) Patent Application Publication
(10) Pub. No.: US 2025/0117694 A1
(43) Pub. Date: Apr. 10, 2025

(54) SENSITIVITY SCORE FOR DRIFT DETECTION OF MACHINE LEARNING MODELS

(71) Applicant: Dell Products L.P., Round Rock, TX (US)

(72) Inventors: Rômulo Teixeira de Abreu Pinho, Niterói (BR); Vinicius Michel Gottin, Rio de Janeiro (BR); Alex Laier Bordignon, Niterói (BR); João Victor Daher Daibes, Niterói (BR)

(21) Appl. No.: 18/483,348

(22) Filed: Oct. 9, 2023

(51) Int. Cl. G06N 20/00

(52) U.S. Cl. CPC G06N 20/00

(57) ABSTRACT

Determining sensitivity scores for implementing drift detection policies are disclosed. A sensitivity score is based on per-sample (un)certainty and overall model (un)certainty. The (un)certainty may be expressed as a distribution and the sensitivity score is based on a distance between the distribution and theoretical distributions. The sensitivity score, which reflects the resiliency of a model to drift, may be used to set policies that determine when drift detection operations are performed. When drift is detected, the models may be retrained and redeployed.

### FIELD OF THE INVENTION

Embodiments of the present invention generally relate to drift in machine learning models. More particularly, at least some embodiments of the invention relate to systems, hardware, software, computer-readable media, and methods for defining machine learning model policies based on drift detection scoring.

### BACKGROUND

Machine learning models come in a variety of types including, but not limited to, supervised, unsupervised, and reinforcement learning. In addition, machine learning models may relate, by way of example, to regression analysis, logistic regression, cluster analysis, and statistical classification. A common problem in machine learning models relates to detecting changes in their performance. The drop in performance of a machine learning model is often referred to as drift.

In machine learning classification models, drift is revealed when data used for inference changes over time. This is an example of data drift. Drive is also revealed with the relationships between the input and the output vary compared to when the model was trained. This is an example of concept drift.

Detecting drift can present various issues. For example, determining the frequency at which the performance of the model is assessed for drift can be costly. Checking or evaluating a machine learning model for drift requires data to be collected and stored for analysis. If the checks are performed too frequently, computing resources may be spent unnecessarily, particularly when drift is not detected. On the other hand, checks that are performed too infrequently may cause drift to be discovered after the performance of the machine learning model has dropped to unacceptable levels.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of implementing drift detection operations and policies;

FIG. 2 discloses aspects of synthetically generated model outputs;

FIG. 3 discloses aspects of model certainty or uncertainty;

FIG. 4 discloses example distributions;

FIGS. 5A, 5B, 5C, and 5D disclose aspects of synthesized distributions and sensitivity scores;

FIG. 6 discloses aspects of a method for determining sensitivity scores and/or implementing drift detection policies; and

FIG. 7 discloses aspects of a computing entity, device, or system.

### DETAILED DESCRIPTION OF SOME EXAMPLE EMBODIMENTS

Embodiments of the present invention generally relate to machine learning and drift assessment. More particularly, at least some embodiments of the invention relate to systems, hardware, software, computer-readable media, and methods for generating and applying drift assessment policies to machine learning models.

Embodiments of the invention are described with reference to machine learning classification models. In a classification model, the output is a set of probability values indicating the likelihood that an input sample belongs to any of the classes known or learned by the classification model. The probability values are typically normalized using, in one example, a softmax function. The softmax function converts the set of likelihoods into a probability distribution, where all of the class probabilities sum to one. The predicted or inferred class of a sample is the class with the highest probability vale in the output of the softmax function.

The certainty of classification models can vary from one classification model to the next. For example, the output of the softmax function may be a probability distribution when the probability of the predicted class is much higher than the probabilities of the other classes. Other classification models have comparatively lower certainty. For example, even when the training accuracy is high, the difference between the probability of the predicted class and the probability of other classes is relatively small across the training data set.

Because of data and/or concept drifts in classification models, the classification models begin to misclassify samples. One consequence of drift is that the outcome of the softmax favors a class that is different from the expected class for a given sample. Classification models that are overall less certain about their predictions are, in general, the ones that are most sensitive to drifts. Small changes in the data or in the models' concepts can lead to changes in the softmax output at inference time.

In addition, the certainty in the prediction of a class for an input sample is associated with the entropy of the softmax outcome associated with that sample. More specifically, low entropy indicates that the predicted class's probability is much higher than probabilities of the other classes. High entropy suggests that all classes have roughly the same probability.

In order to apply different policies (e.g., frequency for evaluating classification models for drift), embodiments of the invention generate or determine a sensitivity score for each classification model. More specifically, for a classification model M trained with dataset Dₜ and validated with dataset Dᵥ, embodiments of the invention determine a normalized entropy e associated with the softmax outcome of each correctly classified validation sample belonging to Dᵥ. This yields a distribution of entropy values Pₑ across the validation data set Dᵥ. This distribution of entropy values will be skewed towards one if the classification model has high certainty about its predictions. Conversely, this distribution of entropy values will be skewed towards zero if the classification model is overall less certain about its predictions.

To obtain a drift sensitivity score S for a trained model, the convex Wasserstein distance W of its entropy probability Pₑ relative to both a theoretically maximally certain P_{c} and the maximally uncertain Pᵤ entropy distributions. The drift sensitivity score, by way of example, may be expressed as: S=W(P_{c}, Pₑ)/(W(P_{c}, Pₑ)+W(Pₑ, Pᵤ)).

Advantageously, the Wasserstein distance correctly captures monotonically increasing differences between distributions as compared to other divergences such as the KL-divergence and the Jansen-Shannon distance.

The score S will be in the interval [0, 1], with zero indicating that the classification model is less sensitive to drifts and one indicating that the model is very sensitive to drifts. Using the drift sensitivity score, users (or specialists) can define thresholds (or implement heuristics) to determine how frequently drift detection policies should be executed for a given classification model under operation. This can reduce the costs associated with performing drift detection operations too frequently to too infrequently.

Embodiments of the invention thus relate to a drift sensitivity score based on the entropy distribution of the softmax outcome of trained machine learning models and on the convex Wasserstein distance W between theoretically maximally certain and maximally uncertain entropy distributions.

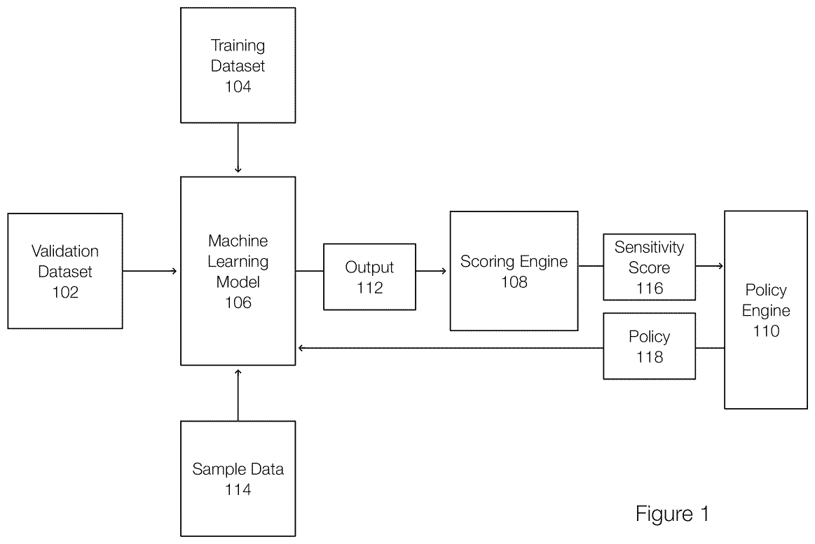

FIG. 1 discloses aspects implementing drift detection operations and policies. FIG. 1 illustrates a machine learning model 106 (M) that is trained with a training dataset 104 (Dₜ). A validation dataset 102 (Dᵥ) may be used to validate the machine learning model 106. Once trained, the machine learning model 106 may generate inferences for sample data 114.

In one example, the model 106 is a classification model that predicts one of k classes for some input. More specifically, for an input (e.g., sample data 114 or x), the model 106 generates an output 112. The output 112 is a distribution indicating the likelihood that the sample data 114 (x) belongs to one of the classes on which the model was trained. More specifically embodiments of the invention may be implemented in the context of a trained classification model, M, that predicts one of k classes for some input.

The output 112 of the model 106 may be provided to a scoring engine 108 that is configured to generate a sensitivity score 116 for the model 106. The policy engine 110 may use the sensitivity score 116 to apply a policy 118 to the model 106. The policy 118, by way of example, may specify how or when the model 106 is evaluated for drift. The sensitivity score 116 reflects the resiliency of the model 106 with respect to both data drift and/or concept drift. The policy 118 applied to models that are sensitive to drifts may require drift detection operations to be performed more frequently than to models that are comparatively less sensitive to drift.

Advantageously, a sensitivity score can be determined and drive evaluation policies can be generated and applied independently of characteristics such as, but not limited to, a model's architecture, the nature of the input to the model, and/or the number of output classes k. In some examples, embodiments of the invention are completely agnostic with respect to these our invention is completely agnostic with respect to these characteristics and are capable of generating and assigning drift sensitivity scores to multiple models.

The process of generating a sensitivity score includes characterizing the per-sample certainty or uncertainty. Embodiments of the invention incorporate or use the notion of entropy to define the certainty or confidence with which a trained model predicts the class of input samples. In one example, entropy in the context of embodiments of the invention is defined as follows (see https://en.wikipedia.org/wiki/Entropy_(information_theory), which is incorporated by reference in its entirety):

$$H ( p ) = - {\sum }_{i = 1}^{n} p ( i ) * log ( p ( i ) ) .$$

Given a message with n possible symbols, each with probability p(i), H(p) measures how much surprise is encoded in the message. H(p) equals to zero when p(i)=1, for some symbol i, indicating that messages will always contain that single symbol. Conversely, H(p) achieves is maximum value when

$$p ( i ) = \frac{1}{n} , ∀ i ,$$

indicating that it is impossible to predict which symbols will appear in the message.

Using these concepts, a normalized entropy Hₙₒᵣₘ(p) of an arbitrary distribution p is defined as:

$${H}_{norm} ( p ) = {H}_{2} ( p ) , ∈ [ 0 , 1 ] .$$

In the definition of H(p), n is equivalent to the number of classes k known by the model M (e.g., the model 106). Next, a second entropy measurement H₂(p) that includes the entropy of the top two values in p, is normalized to form a new distribution p′. As a result, H(p′) is a binary entropy of p′, which is, by definition, in the interval [0,1].

More specifically, the second entropy measurement uses the two top values in p. When H(p′) is close to zero, this indicates that one class is dominant with respect to the second class. This, in turn, indicates that the class dominates overall other classes as well.

If H(p′) is close to one, this indicates that the top two classes have roughly the same probability. This further suggests that the model is uncertain about which of at least these two classes should be assigned to the input sample.

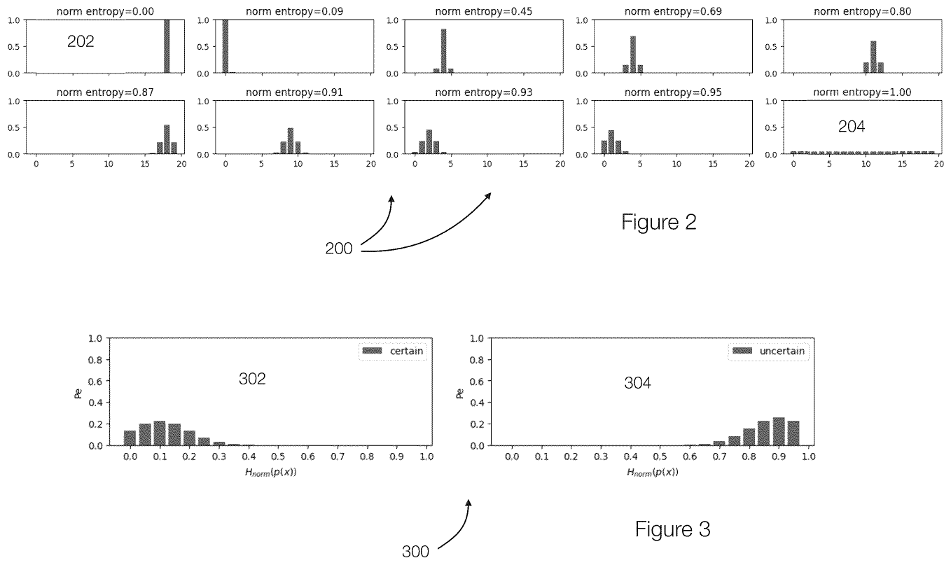

FIG. 2 discloses synthetic examples of softmax model outputs for n=k=20 classes and the associated value of Hₙₒᵣₘ(p). As illustrated in the plots 200, the normalized entropy value increases from zero (e.g., in the plot 202) to one (e.g., in the plot 204) as the top two values in the model's output convey less certainty about the predicted class.

More specifically, the plots 200 illustrates that the outputs (or the softmax outputs) and their associated normalized entropy values approach 1 (one) as the output conveys less certainty about the predicted class. The example with n=k=20 classes shown in FIG. 1 provides one example of how Hₙₒᵣₘ(p) behaves and how Hₙₒᵣₘ(p) encodes certainty in the predictions. Further, Hₙₒᵣₘ(p) is completely agnostic about the number of classes.

Embodiments of the invention may also characterize the overall model certainty or uncertainty. Each prediction or inference output by the model 106 for an input sample x (e.g., sample data 114) is a distribution. Thus, Hₙₒᵣₘ(p(x)) can be configured to encode the certainty in the prediction. To characterize the overall certainty of the model 106 M, Hₙₒᵣₘ(p(x)) is computed for all x∈Dᵥ (all sample data in the validation dataset 102). In addition, the distribution of Hₙₒᵣₘ(p(x)) across Dᵥ is defined as Pₑ.

FIG. 3 discloses aspect of model certainty and model uncertainty. More specifically, the plots 300 include a plot 302 illustrating model certainty and a plot 304 illustrating model uncertainty. If Pₑ is skewed toward zero, as illustrated in the plot 302, the model is, overall, uncertain about its predictions. If Pₑ is skewed towards 1, the model is comparatively more certain about its predictions. In one example, Pₑ is generated using the validation dataset (e.g., validation dataset 102 for the model 106) rather than using the training dataset (e.g., the training dataset 104 for the model 106).

By characterizing the overall certainty or uncertainty of the model and the certainty or uncertainty of the model on a per-sample basis, embodiments of the invention are prepared to determine or generate a drift sensitivity score. Consider an example where Hₙₒᵣₘ(p(x)) is close to zero for some input sample x. When Hₙₒᵣₘ(p(x)) for an input sample x is close to zero, this suggests that the class predicted by the model (i.e., the one with the highest probability in the softmax output of the model for the input sample, has a probability that is much higher than the probabilities of the other classes learned by the model.

If a drift corresponds to a situation where the predicted class is different from the expected class, a considerable change in the model's outcome should occur to make the original class change, given the large difference between the top two classes. This indicates that the model is likely resilient to changes in the input sample x. For instance, in some sensor data, the model may be more resilient to perturbations (e.g., noise) applied to x.

If, on the other hand, Hₙₒᵣₘ(p(x)) is close to one, any small change in the model's outcome may lead to a different class being assigned to x. This creates a notion of how sensitive a model may be to perturbations considering a single sample.

To quantify how sensitive a model may be to changes in how data are classified overall, the distribution Pₑ defined above is employed. In one example, two additional distributions are used. These additional distributions serve as references in the context of quantifying the sensitivity. These models include:
P_{c}, which is the theoretically maximally certain distribution, and
Pᵤ, which is the theoretically maximally uncertain distribution.

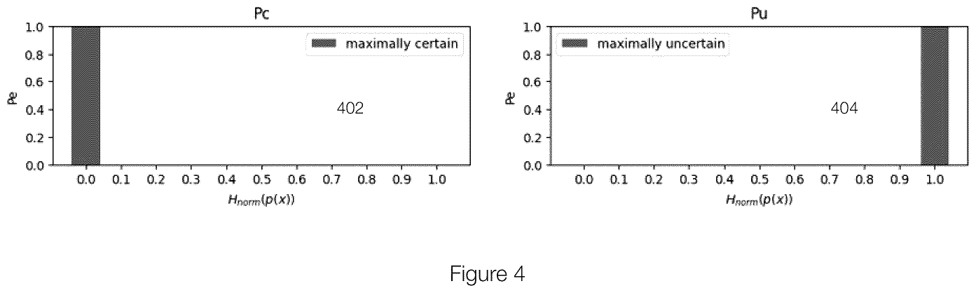

FIG. 4 illustrates example plots of these theoretical distributions. The plot 402 represents a maximally certain plot of P_{c}, which corresponds to Pₑ(Hₙₒᵣₘ(p(x))=0)=1. The plot 404 represents a maximally uncertain plot of Pᵤ corresponds, which corresponds to Pₑ(Hₙₒᵣₘ(p(x))=1)=1. These plots 402 and 404 are theoretical from the perspective that these distributions are very unlikely for all samples in a validation dataset.

After Pₑ, P_{c}, and Pᵤ have been determined, the drift sensitivity score for a model, such as the model 106, can be determined. As previously suggested, the Wasserstein distance W(P1,P2) between distributions may be employed (see https://en.wikipedia.org/wiki/Wasserstein_metric, which is incorporated by reference in its entirety.

In one example, the Wasserstein distance measures the effort needed to transform P1 into P2. This distance, compared to other divergence metrics between distributions, has the advantage of increasing monotonically as the difference (in shape) between distributions increases. In one example, embodiments of the invention measure the distance between Pₑ and the two distributions P_{c}, and Pᵤ.

In one example, a normalized drift sensitivity score S is defined as follows:

$$S = \frac{W ( P c , P e )}{W ( P c , P e ) + W ( P e , P u )} .$$

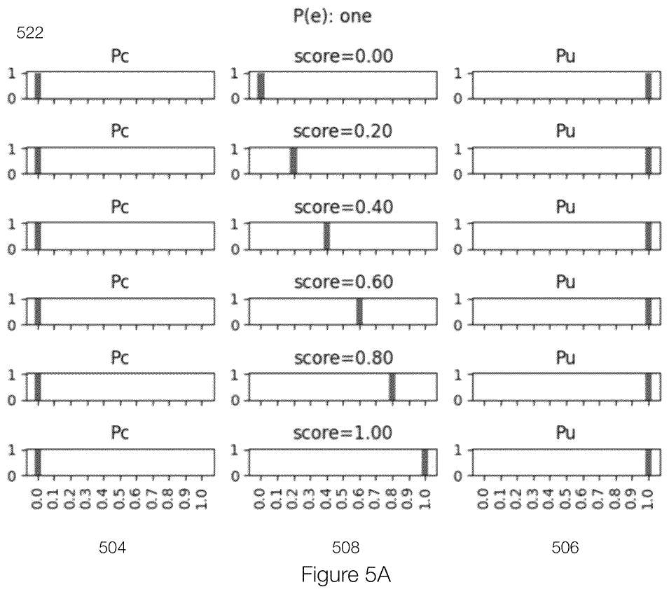

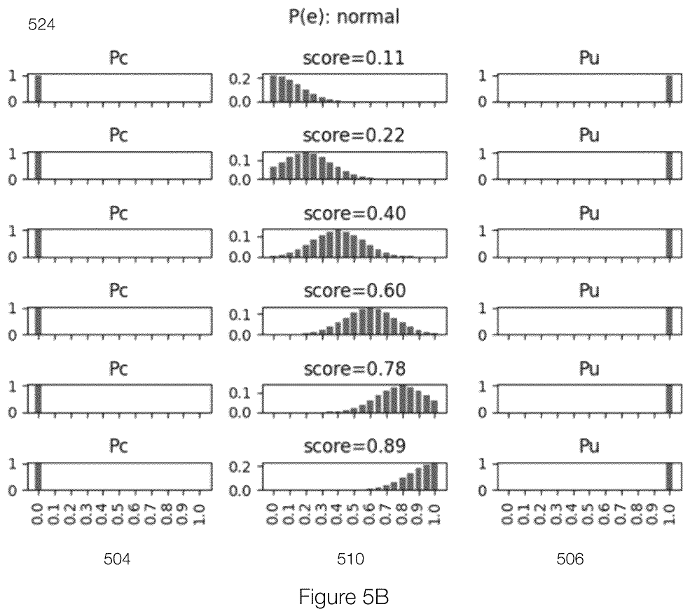

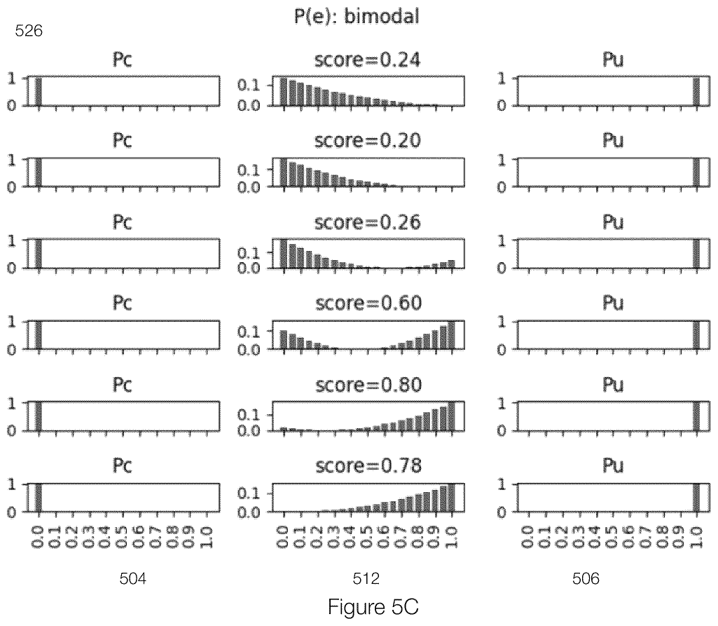

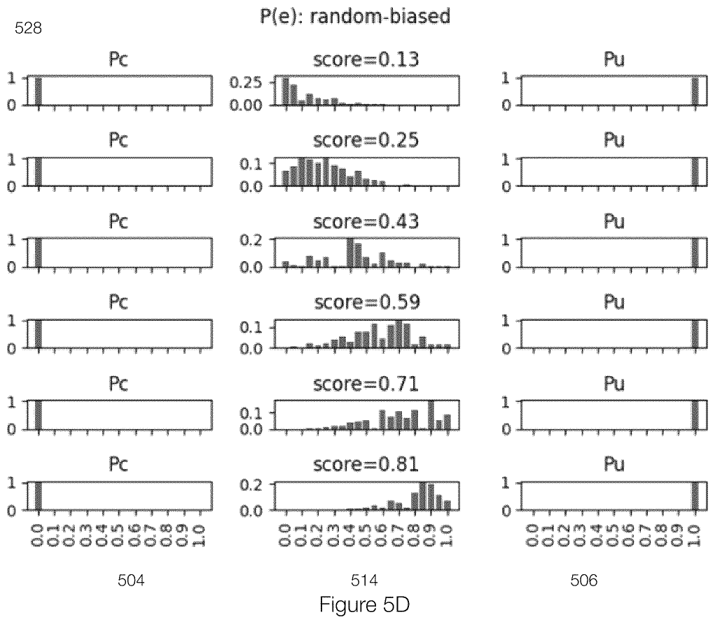

FIGS. 5A, 5B, 5C, and 5D illustrate different examples of synthesized distributions Pₑ to represent different types of model uncertainty and how the model certainty or uncertainty relates to the drift sensitivity score.

Each of FIGS. 5A-5D illustrates a maximally certain distribution P_{c} 504 in a left column and the maximally uncertain distribution Pᵤ 506 in a right column. The middle columns (508 in FIG. 5A, 510 in FIG. 5B, 512 in FIG. 5C, and 514 in FIG. 5D, represent synthesized examples of Pₑ(P(e) in the Figures). The middle columns 508, 510, 512, and 514 illustrate the distributions of Pₑ and the respective drift sensitivity scores as Pₑ gets further away from P_{c} and closer to Pᵤ, as determined by the Wasserstein distance measure.

The plots 522 in FIG. 5A illustrates a theoretical limit of model (un) certainties by defining Pₑ=1 at some value Hₙₒᵣₘ(p(x))=h. This is a theoretical limit because it is very unlikely that a model will ever yield Hₙₒᵣₘ(p(x))=h for all x∈Dᵥ. However, as illustrated in column 508, the sensitivity score goes from zero to one as Pₑ departs from P_{c} and moves towards Pᵤ.

The plots 524 in FIG. 5B illustrate that Pₑ is synthesized as a normal distribution that is centered at some Hₙₒᵣₘ(p(x))=h, which is a more likely assumption than in the assumption illustrated in FIG. 5A. In the example of FIG. 5B, the sensitivity score approaches one as the distribution's mass moves towards Pᵤ and away from P_{c}.

A similar behavior is illustrated in the plots 526 shown in FIG. 5C. In FIG. 5C, a synthesized bimodal distribution was used. As in FIG. 5B, the sensitivity score approaches 1 as the distribution's mass moves towards Pᵤ and away from P_{c}.

FIG. 5D illustrates a more realistic scenario. In the example of FIG. 5D, the plots 528 illustrate that the distribution Pₑ was randomized, but with a shifting bias from zero to one. Despite the wider spread of Hₙₒᵣₘ(p(x)) across the entire domain, the drift sensitivity score follows the distribution's bias and correctly reflects the shift from P_{c} towards Pᵤ.

In one example, the sensitivity score S is computed on the validation dataset, although other datasets (e.g., including subsequent data samples) may be used to determine the drift sensitivity score. Using the validation dataset provides certain advantages. For example, validation datasets are used to ensure that a model does not overfit to the training data. One benefit of machine learning models relates to the capability of a trained model to generalize to data the model has never seen. Validation datasets serve this purpose because the validation datasets are kept apart from the training dataset used to train the model. The validation dataset may correspond to a portion of the training dataset that is set aside in each training round to compute model metrics (e.g., accuracy) or may correspond to a fixed dataset on which the model will be tested after training is complete.

A model that is overfit to the training data potentially impacts the drift sensitivity score. At the extreme, overfitting is much like memorizing the training data inside the model parameters. As a result, the model would likely be very certain about the classes assigned to the training samples and the sensitivity score on the training dataset, Dₜ, would be very close to zero.

However, overfitted models are, by nature, very sensitive to drifts and overfitted models do not typically generalize well to unseen data. For this reason, computing the sensitivity score on the validation dataset Dᵥ is a more robust approach, because the behavior of the model on the validation dataset is similar to what would be expected once the model is deployed.

Finally, once the sensitivity score is calculated, thresholds can be defined or heuristics can be used to determine how frequently drift detection policies should be executed for a given model under operation. Generally, models whose sensitivity score is close to zero requires fewer drift detection checks because they are potentially more resilient to data perturbations. If the drift sensitivity score is closer to one, more drift detection checks should be executed.

For example, a model may be deployed to the edge. In edge environments, models may be deployed for fast or even real-time decision making and may be subject to strict restrictions with respect to processing and energy consumption. Drift detection approaches based on model performance thus require either i) that the results of the model are communicated frequently to a central processing node, which then performs drift detection or ii) an efficient way to perform drift detection is implemented at the edge nodes. Embodiments of the invention allow drift detection to be more efficiently implemented at the edge or in edge nodes. This advantageously avoids or reduces communication and networking overhead associated with frequently communicating the results of the model to the central processing node. More specifically, the drift detection approach in an environment such as an edge environment can be implemented using drift policies, which are based on the sensitivity score of the model. Models that are resilient to drift can be evaluated less frequently and the computing environment thus benefit from the lower frequency of drift detection operations.

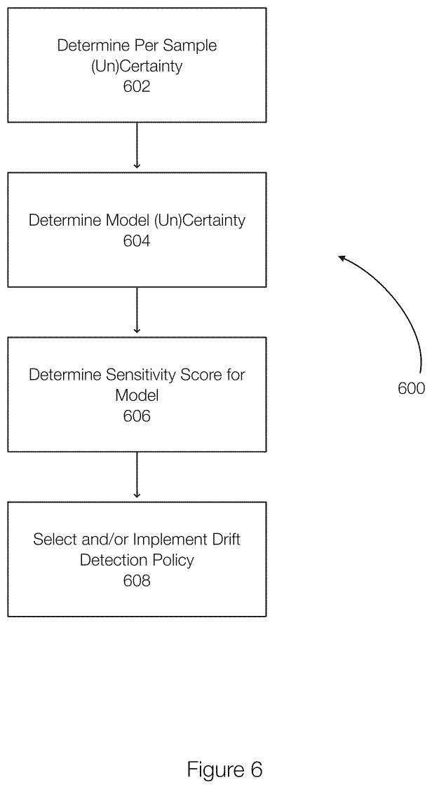

FIG. 6 discloses aspects of a method for determine sensitivity scores for models and/or implementing drift detection policies. The method 600 may include determining 602 a certainty or an uncertainty (an (un)certainty) of a model on a per-sample basis. In one example, determining the certainty may include determining an entropy of a sample. The entropy values may be normalized. A second entropy may be determined for the top two values. Embodiments of the invention may operate using a single entropy determination or multiple entropy determinations.

Next, the model (un)certainty is determined 604. The model (un)certainty may be determined using the validation dataset. IN one example, an entropy distribution for the model is determined.

Using maximally certain and uncertain distributions, a sensitivity score for the model is determined 606. The sensitivity score is based on a distanced between the distribution of entropy across the validation dataset and the maximally certain/uncertain distributions. Once the sensitivity score is determined, drift detection policies can be selected and implemented 608. The policy may specify a frequency at which drift detection operations are performed and implementing the policy may include performing the drift detection operations. If no drift is detected, the model may continue to operate. If drift is detected, the model may require retraining with the same or a different training dataset.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods, processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, machine learning operations, sensitivity score determination operations, policy related operations, or the like. More generally, the scope of the invention embraces any operating environment in which the disclosed concepts may be useful.

New and/or modified data collected and/or generated in connection with some embodiments, may be stored in a data environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, detection, and/or cloning, operations initiated by one or more clients or other elements of the operating environment.

Example cloud computing environments, which may or may not be public, include storage environments that may provide data functionality for one or more clients. Another example of a cloud computing environment is one in which processing, data protection, and other services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data system components such as databases, storage servers, storage volumes (LUNs), storage disks, replication services, backup servers, restore servers, backup clients, and restore clients, for example, may likewise take the form of software, physical machines, containers, or virtual machines (VM), though no particular component implementation is required for any embodiment.

As used herein, the term ‘data’ is intended to be broad in scope. Thus, that term embraces, by way of example and not limitation, data samples that may be input to machine learning models, outputs of machine learning models, or the like.

It is noted any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method, comprising: determining a certainty of a machine learning model on a per-sample basis, determining an overall certainty of the machine learning model, determining a sensitivity score for the model based on the overall certainty of the machine learning model, a maximally certain distribution, and a maximally uncertain distribution, and executing a drift detection policy on the machine learning model, wherein the drift detection policy is based on the sensitivity score of the machine learning model.

Embodiment 2. The method of embodiment 1, wherein determining the certainty of the machine learning model on the per-sample basis includes determining an entropy of an output of the machine learning model for a sample.

Embodiment 3. The method of embodiment 1 and/or 2, further comprising normalizing the entropy of the output.

Embodiment 4. The method of embodiment 1, 2, and/or 3, further comprising determining and normalizing a second entropy that is based on two top values included in the output.

Embodiment 5. The method of embodiment 1, 2, 3, and/or 4, wherein determining the overall certainty includes defining a first distribution of the entropies of each sample in a validation dataset.

Embodiment 6. The method of embodiment 1, 2, 3, 4, and/or 5, wherein determining the sensitivity score includes determining a distance between the first distribution and the maximally certain distribution and the maximally uncertain distribution.

Embodiment 7. The method of embodiment 1, 2, 3, 4, 5, and/or 6, wherein the distance is a Wasserstein distance.

Embodiment 8. The method of embodiment 1, 2, 3, 4, 5, 6, and/or 7, wherein the drift detection policy specifies a frequency at which the drift detection policy is performed on the machine learning model.

Embodiment 9. The method of embodiment 1, 2, 3, 4, 5, 6, 7, and/or 8, wherein the frequency of the drift detection policy increases as the sensitivity score approaches 1.

Embodiment 10. The method of embodiment 1, 2, 3, 4, 5, 6, 7, 8, and/or 9, wherein a resiliency of the machine learning model to data drift and/or context drift is presumed to decrease as the sensitivity score approaches 1.

Embodiment 11 A system, comprising hardware and/or software, operable to perform any of the operations, methods, or processes, or any portion of any of these, disclosed herein.

Embodiment 12 A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

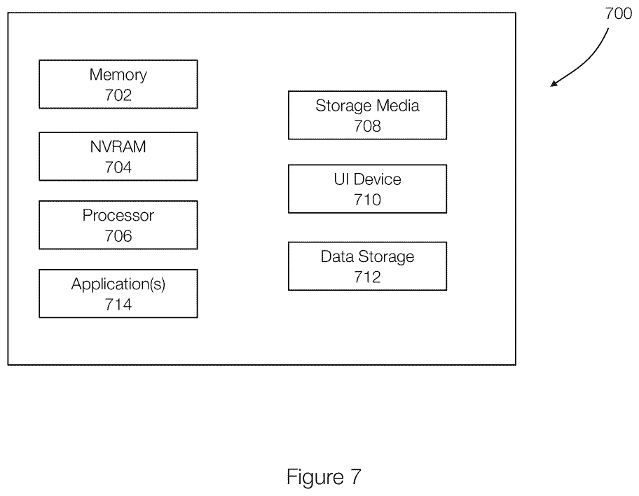

With reference briefly now to FIG. 7, any one or more of the entities disclosed, or implied, by the Figures and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
determining a certainty of a machine learning model on a per-sample basis;
determining an overall certainty of the machine learning model;
determining a sensitivity score for the model based on the overall certainty of the machine learning model, a maximally certain distribution, and a maximally uncertain distribution; and
executing a drift detection policy on the machine learning model, wherein the drift detection policy is based on the sensitivity score of the machine learning model.

2. The method of claim 1, wherein determining the certainty of the machine learning model on the per-sample basis includes determining an entropy of an output of the machine learning model for a sample.

3. The method of claim 2, further comprising normalizing the entropy of the output.

4. The method of claim 3, further comprising determining and normalizing a second entropy that is based on two top values included in the output.

5. The method of claim 1, wherein determining the overall certainty includes defining a first distribution of the entropies of each sample in a validation dataset.

6. The method of claim 5, wherein determining the sensitivity score includes determining a distance between the first distribution and the maximally certain distribution and the maximally uncertain distribution.

7. The method of claim 1, wherein the distance is a Wasserstein distance.

8. The method of claim 1, wherein the drift detection policy specifies a frequency at which the drift detection policy is performed on the machine learning model.

9. The method of claim 8, wherein the frequency of the drift detection policy increases as the sensitivity score approaches 1.

10. The method of claim 9, wherein a resiliency of the machine learning model to data drift and/or context drift is presumed to decrease as the sensitivity score approaches 1.

11. A non-transitory storage medium having stored therein instructions that are executable by one or more hardware processors to perform operations comprising:
determining a certainty of a machine learning model on a per-sample basis;
determining an overall certainty of the machine learning model;
determining a sensitivity score for the model based on the overall certainty of the machine learning model, a maximally certain distribution, and a maximally uncertain distribution; and
executing a drift detection policy on the machine learning model, wherein the drift detection policy is based on the sensitivity score of the machine learning model.

12. The non-transitory storage medium of claim 11, wherein determining the certainty of the machine learning model on the per-sample basis includes determining an entropy of an output of the machine learning model for a sample.

13. The non-transitory storage medium of claim 12, further comprising normalizing the entropy of the output.

14. The non-transitory storage medium of claim 13, further comprising determining and normalizing a second entropy that is based on two top values included in the output.

15. The non-transitory storage medium of claim 11, wherein determining the overall certainty includes defining a first distribution of the entropies of each sample in a validation dataset.

16. The non-transitory storage medium of claim 15, wherein determining the sensitivity score includes determining a distance between the first distribution and the maximally certain distribution and the maximally uncertain distribution.

17. The non-transitory storage medium of claim 11, wherein the distance is a Wasserstein distance.

18. The non-transitory storage medium of claim 11, wherein the drift detection policy specifies a frequency at which the drift detection policy is performed on the machine learning model.

19. The non-transitory storage medium of claim 18, wherein the frequency of the drift detection policy increases as the sensitivity score approaches 1.

20. The non-transitory storage medium of claim 19, wherein a resiliency of the machine learning model to data drift and/or context drift is presumed to decrease as the sensitivity score approaches 1.
